(19) United States
(12) Patent Application Publication
(10) Pub. No.: US 2016/0364137 A1
(43) Pub. Date: Dec. 15, 2016

(54) MULTI-TOUCH VIRTUAL MOUSE

(71) Applicant: INTEL CORPORATION, Santa Clara, CA (US)

(72) Inventors: Guangyu Ren, Shanghai (CN); Lili M. Ma, Shanghai (CN); Hantao Ren, Shanghai (CN); Arvind Kumar, Beaverton, OR (US); John J. Valavi, Beaverton, OR (US); Jose Manuel Picado Leiva, Corvallis, OR (US); Kedar A. Dongre, Hillsboro, OR (US)

(21) Appl. No.: 14/773,939

(22) PCT Filed: Dec. 22, 2014
(86) PCT No.: PCT/US2014/071797

§ 371 Date: Sep. 9, 2015

(51) Int. Cl. G06F 3/0488; G06F 3/0484; G06F 3/0486; G06F 3/0482

(52) U.S. Cl. CPC G06F 3/04886; G06F 3/0482; G06F 3/04845; G06F 3/0486; G06F 3/04883; G06F 3/04817

(57) ABSTRACT

In accordance with some embodiments, a touch input device such as a touch screen or track pad or touch pad may be operated in mouse mode by touching the screen simultaneously with more than one finger. In one embodiment, three fingers may be utilized. The three fingers in one embodiment may be the thumb, together with the index finger and the middle finger. Then the index finger and the middle finger may be used to left or right click to enter a virtual mouse command.

### BACKGROUND

This relates generally to the use of mouse commands to control a touch screen cursor.

In conventional processor-based systems, such as laptop computers, desktop computers, cellular telephones, media playing devices such as game devices and other such devices, touch screen entered mouse commands provide an alternative to the use of a keyboard or mouse entered cursor command. For example, mouse commands may be used to move a cursor in order to make a selection on a display screen. Conventionally a mouse is held in the user's hand and movement of the mouse moves the cursor. Clicking on a button on the mouse enables the selection of a displayed object overlaid by the cursor.

In some cases, mobile users may find that use of a mouse is awkward because it requires carrying an additional device which could be larger than the actual processor-based device such as cellular telephone. Also, with small screen devices, such as those found on cellular telephones, there may not be enough screen space to select some smaller features displayed on the screen. Another problem is that it may be difficult for the user to accurately place the mouse cursor at a particular location in the case of small icon buttons or links on a display screen.

### BRIEF DESCRIPTION OF THE DRAWINGS

Some embodiments are described with respect to the following figures:

FIG. 1 is a top view of the user's right hand on a display screen according to one embodiment;

FIG. 2 is a top view of a user's right hand on a display screen according to one embodiment;

FIG. 3 is a top view of a user's pointer finger at the center of the display screen according to one embodiment;

FIG. 4 is a top view of a user's hand right clicking on the left side of the display screen according to one embodiment;

FIG. 5 is a top view of the user's hand on the right side of the display screen according to one embodiment;

FIG. 6 is a top view of the user's hand on the bottom center of the display screen according to one embodiment;

FIG. 7 is a top view on the bottom left edge of the display screen according to one embodiment;

FIG. 8 is a top view of the user's hand on the bottom right edge of the display according to one embodiment;

FIG. 9 is a top view of a left mouse click operation according to one embodiment;

FIG. 10 is a top view of a right mouse click operation according to one embodiment;

FIG. 11 is a schematic depiction of a filter according to one embodiment;

FIG. 12 is a schematic depiction of a filter driver architecture according to one embodiment;

FIG. 13 is a schematic depiction of the filter driver of FIG. 12 according to one embodiment;

FIG. 14 is a flow chart for a filter driver state machine according to one embodiment;

FIG. 15 is a top view of a user activating a virtual mouse mode according to one embodiment;

FIG. 16 is a top view of a user beginning a cursor move command according to one embodiment;

FIG. 17 is a top view of a user in the course of a cursor move command according to one embodiment;

FIG. 18A is a top view of a left mouse click operation according to one embodiment;

FIG. 18B is a top view of a right mouse click operation according to one embodiment; and

FIG. 19 is a flow chart for one embodiment.

### DETAILED DESCRIPTION

A filter may be inserted into a touch input stream for touch gesture recognition. Then the stream may be switched to a mouse emulator in some embodiments. However, these concepts may also be extended to other input/output devices. For example, a filter in an audio input stream may be used for speech recognition but may then switch the stream to a keyboard emulator that performs speech detects translation. Thus the examples that follow in the context of a touch input stream should not be considered as limiting the scope of this disclosure.

A touch screen may operate in different modes in one embodiment. In the normal mode, the screen responds to single-finger, multi-finger and pen/stylus and all associated gestures as defined by the operating system. Upon detecting a specific gesture (defined below), the touch screen enters a virtual mouse mode. In this mode, the normal touch responses are disabled, and the touch screen acts like a virtual mouse/touchpad. When all fingers are lifted, the touch screen immediately returns to the normal mode in one embodiment.

As used herein a touch input device is a multi-touch input device that detects multiple fingers touching the input device.

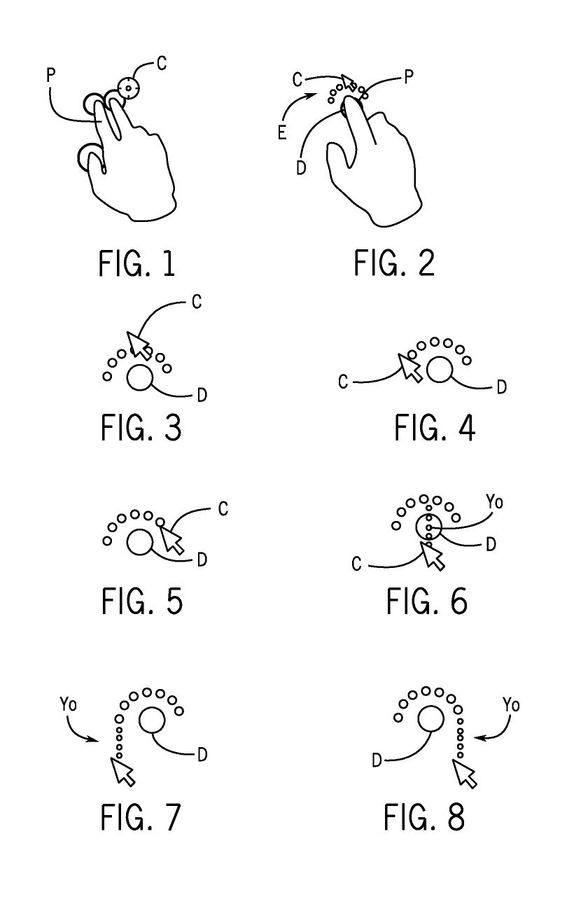

To start the virtual mouse mode in one embodiment, the user uses a three-finger gesture, touching the screen with any three fingers as shown in FIG. 1. The user holds the gesture for a few milliseconds in one embodiment. One of the fingers, called the pointer finger, controls the mouse cursor. In the starting three-finger gesture, the pointer finger is the finger P that is in the middle (obtained by comparing x values of the three fingers' positions) of the three fingers touching the screen. The pointer finger is above at least one of the other fingers, so that the cursor C is easily visible by the user. The user holds the pointer finger on-screen to stay in virtual mouse mode.

The user can move the cursor by simply moving the pointer finger around the screen. The cursor is positioned around the pointer finger at a slight distance to make sure it is visible to user, and so that it also seems connected to the pointer finger. Its exact position depends on the position of the pointer finger in the screen.

One problem with using finger contacts as mouse inputs is to enable the cursor to cover the entire screen. This includes the edges and the corners. So, the cursor is dynamically moved to a diff erent position relative to pointer finger depending on which part of the screen the cursor is in. If the pointer finger is above the center of the screen, as shown in FIG. 2, the cursor C is positioned centrally over an imaginary half ellipse E that has at its center, the pointer finger P.

Depending on the position of the pointer finger along the x axis extending across the screen, the cursor is positioned at a different point around the ellipse. The pointer finger's touch point is represented with a circle D in FIGS. 2-8. When the pointer finger is in the center of the screen, the cursor C is positioned above the pointer finger at D as shown in FIG. 3. When the pointer finger is close to the left edge of the screen, the cursor is positioned along the ellipse on the left of the pointer finger as shown in FIG. 4. When the pointer finger is close to the right edge, the cursor is positioned along the ellipse on the right of the pointer finger as shown in FIG. 5. If the pointer finger is below the center of the screen, the cursor is positioned as described above, except that a y-offset (Yo) is added to the y value of the cursor position. This allows the cursor C to reach the bottom of the screen as shown in FIG. 6.

The value of y-offset depends on the distance from the pointer finger to the center of the screen along the y axis. When the pointer finger moves between the cases mentioned above, the cursor smoothly moves around and across the half ellipse. This approach allows the cursor to reach anywhere in the screen, including corners, without doing jumps, as shown in FIGS. 7 and 8. In FIG. 7, the pointer finger is at the bottom left portion of the screen. In FIG. 8, the pointer finger is in the bottom right position of the screen.

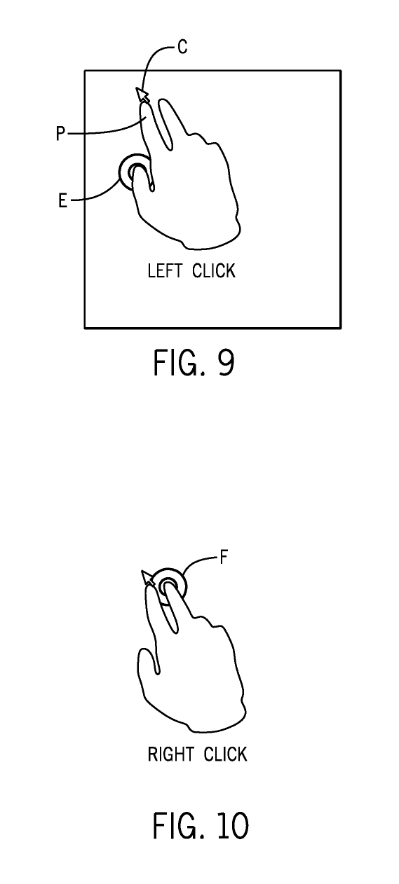

When in virtual mouse mode, the user can perform left and right clicks with any finger other than the pointer finger. Any touch on the left side of the pointer finger, indicated by concentric circles E under the user's thumb, is considered a left click as shown in FIG. 9. Any touch on the right side of the pointer finger, indicated by concentric circles F under the user's middle finger, is considered a right click as shown in FIG. 10. Touch and hold are considered to be mouse button downs, and release is considered to be mouse button up. The user can go back to touch mode (exiting virtual mouse mode) by releasing the pointer finger from the screen or by doing four or more touches with any finger.

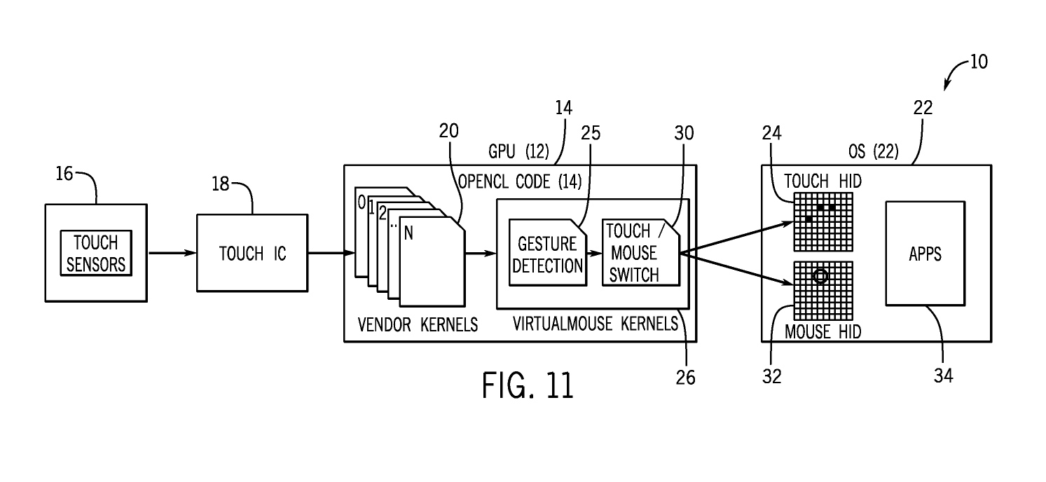

The architecture 10, shown in FIG. 11, performs touch digital processing on graphics engine or graphics processing unit cores 12. This allows running touch processing algorithms with better performance and scalability in some embodiments. Touch processing algorithms are implemented in graphics kernels, which are loaded during initialization. These kernels are written in OpenCL code 14 in one embodiment.

A sequence of kernels is executed on streaming touch data. Touch integrated circuit (IC) 18 vendors provide the kernels (algorithms) 20 to process the raw touch data from touch sensors 16 to produce final touch X-Y coordinates in the graphics processing unit (GPU) 12. This data then goes to the operating system 22 as standard touch human interface device (HID) packets 24.

The architecture allows chaining of additional post-processing kernels, which can further process the touch data before it gets to the OS.

The virtual mouse is implemented in the post-processing kernels 26 as shown in FIG. 11. The post processing solution allows generic algorithms to be run irrespective of the vendor kernels. Since the post processing kernels are run irrespective of the touch IC vendor, they are independent hardware vendor (IHV) agnostic. In order to unify the vendor differences in the data format, the configuration data aligns the data across all the touch IC vendors. Because this firmware is loaded during initialization, runs on the GPU, and does not have any dependence from the operating system, it is also operating system vendor (OSV) independent.

The post processing kernels follow the chained execution model which allows the data to flow from one kernel to next kernel thereby allowing the kernels to execute on previously processed data. Each kernel may be used to adapt to a particular operating system or touch controller. The position of the kernels is specified by the user as part of the configuration. The ability to run on the hardware allows these algorithms to run without bringing up the software stack. Post processing kernels run at the same time as the vendor kernels which relieves the need for any external intervention to copy the data or run the post processing kernels. Gestures and touch data filtering can be implemented in post processing in addition to a virtual mouse function.

The touch controller 18 takes raw sensor data and converts it into clean, digital touch point information that can be used by kernels, OS, or applications. This data is sent as touch HID packets 24. Before going to the OS, HID packets go through the sequence of kernels 20 that run on the GPU, as mentioned above.

The virtual mouse kernel or touch/mouse switch 30 behaves like a state machine. It keeps an internal state that stores the status of the virtual mouse (on or off) and other information relevant to the position of the cursor.

The virtual mouse kernel 26 takes, as an input, the stream of HID packets and performs gesture recognition 25 to detect the gesture used to start the virtual mouse mode. When not in virtual mouse mode, the output of the kernel is touch HID packets 24. When in virtual mouse mode, touch HID packets are blocked by the switch 30 and the output of the kernel is mouse HID packets 32. The touch HID packets or mouse HID packets are passed to the OS 22, which does not know about the filtering of the packets in the switch 30. The OS then handles the mouse and touch mode based on applications (APPS) 34.

The algorithm to calculate the correct coordinates for the mouse, taking into the account the position of pointer finger on the screen, is built into the kernels 26.

An alternative way to implement virtual mouse is to do the touch data processing and touch filtering through a driver. The gesture recognition algorithm and filtering of touch HID packets would be very similar to the ones described above. However doing this through a driver would make the algorithm OS dependent. Being OS dependent involves coordination with the OS vendor to implement the virtual mouse feature.

To make virtual mouse usage even more intuitive to the user, a light transparent overlay image of a mouse may be displayed when the system is in virtual mouse mode. If the user brings the finger on the left close to screen, it is detected using the touch hover capability, and a light transparent image appears near the touch point, suggesting to the user that this touch will result in a left click. Similarly a different image will appear on the right side as a finger comes closer.

In an alternate implementation of the above, the overlay image indicates the left click region and the right click region as soon as the system gets into the virtual mouse mode (i.e. without being dependent on hover capability).

As an alternative to using the whole screen for virtual mouse, a smaller transparent rectangle may appear and act like a virtual touchpad. This touchpad would be overlaid on the contents that the OS or applications are displaying. The user uses this touchpad to control the mouse, as if it were a physical touchpad. Virtual left and right buttons may be provided as well.

Since the virtual mouse does not differentiate the finger that is being used for the left click and right click, it is also possible to use the two hands. When the system enters the virtual mouse mode, the right hand pointer finger can be used to move the cursor, and the person can do the left click with left hand. This can also be used for click and drag. A user can select an item with the pointer finger cursor, use the left hand to click, and keep it on the screen while moving the right hand pointer finger around the screen to do a drag operation.

The algorithm also considers the right-handed person and the left-handed person. It detects it based on the three-finger gesture to enter the virtual mouse mode. The positioning of fingers for a left-handed person is different than the positioning of fingers for a right-handed person. This is an improvement over how the physical mouse is handled today. A user has to make a selection (Windows Control Panel) to set a mouse for right handed or left handed use. In the case of virtual mouse this may be handled on the fly.

According to one embodiment using a device driver, a kernel mode driver creates a virtual mouse device to interface with an operating system (OS) to capture events from a touch panel, translate them into mouse events and expose them to the OS through the virtual mouse device. Also, a set of particular touch screen finger gestures are defined to enable/disable and control mouse activities.

In some embodiments, a user can point more accurately on the screen, can trigger a Mouse Move Over event, and can easily trigger a Right Click event. The user does not need to carry an external mouse. The advantages of some embodiments include (1) seamless switching between mouse mode and normal touch panel working mode, without manually running/stopping any mouse simulation application; (2) software logic is transparent to OS User Mode Modules, and does not rely on any user mode framework; and (3) seamlessly supports both Windows classic desktop mode and Modern (Metro) UI, with the same use experience.

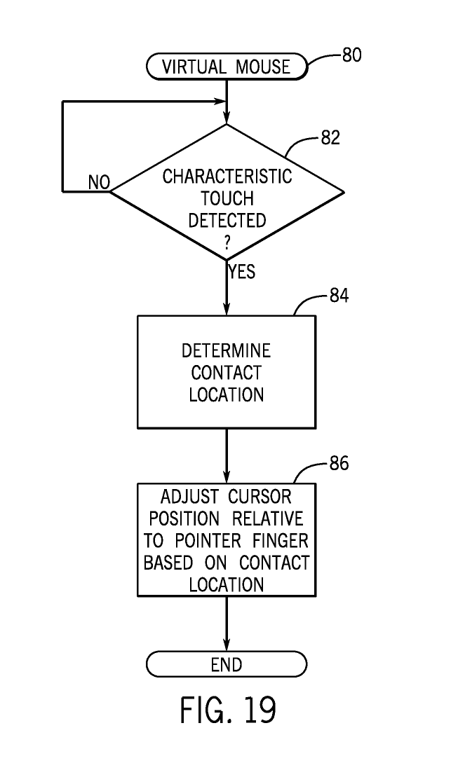

Thus, referring to FIG. 19, a sequence 80 may be implemented in software, firmware and/or hardware. In software and firmware embodiments, it may be implemented by computer executed instructions stored in one or more non-transitory computer readable media such as magnetic, optical or semiconductor storages.

Referring to FIG. 19, a virtual mouse sequence 80 may be implemented in software, firmware and/or hardware. In software and firmware embodiments it may be implemented by computer executed instructions stored in one or more non-transitory computer readable media such as magnetic, optical or semiconductor storages.

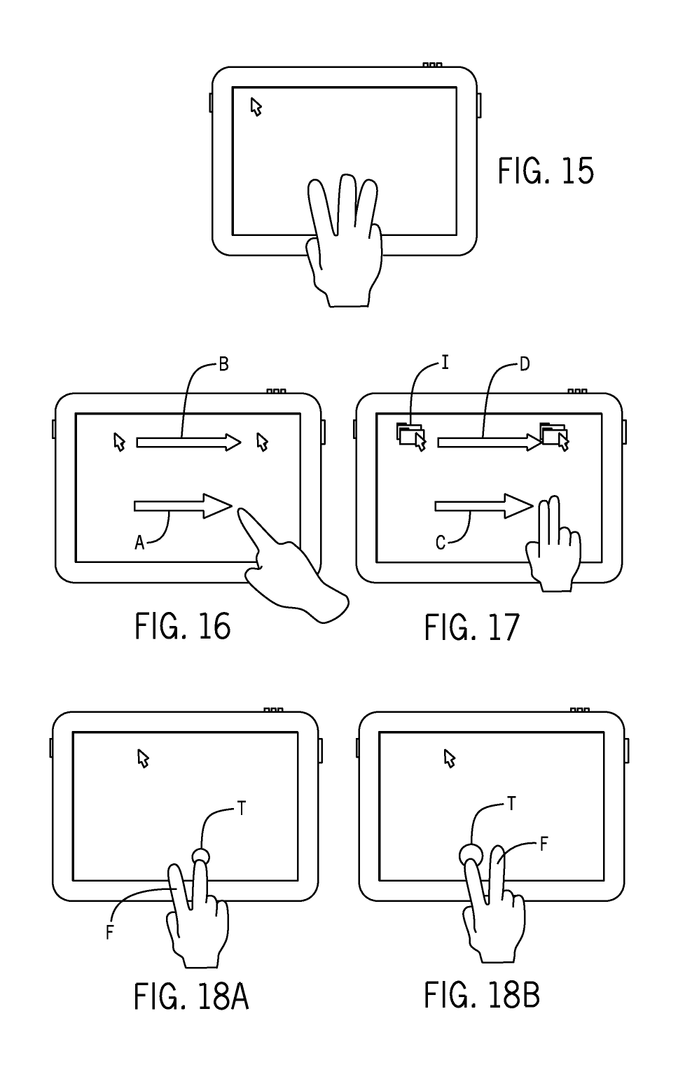

The sequence 80 begins by determining whether a characteristic touch is detected as determined in diamond 82. For example, the characteristic touch may be the three finger touch depicted in FIG. 15 indicative of a desire to enter a virtual mouse mode. If that touch is not detected, the flow does not continue and the device stays in a conventional touch mode.

If the touch mode characteristic has been detected, then the location of contact is determined as indicated in block 84. Specifically, in one embodiment the location on the screen where the middle finger contacts the screen is detected. This location may be a predetermined region of the screen, in one embodiment, including a region proximate the upper edge, a region proximate the lower edge, a region proximate the right edge, and a region proximate the left edge and finally a center region.

Then as indicated in block 86, the cursor position, relative to the pointer finger, is adjusted based on the contact location. For example a center contact is detected in one embodiment and the cursor position may be oriented as indicated in FIG. 3. If contact at the left edge region is detected, then the cursor position may be adjusted as indicated in FIG. 4. Likewise if right edge contact is detected, then the cursor position may be adjusted as indicated in FIG. 5. If bottom edge contact is detected, a cursor position may be as indicated in FIG. 6. If bottom left edge is detected then the FIG. 7 configuration may be used and if bottom right edge is detected the configuration shown in FIG. 8 may be used. The same techniques may be used for the upper left and upper right edges. Of course other conventions may also be used in addition or as an alternative to defining distinct regions on the display screen.

In addition, in some embodiments a Y offset is added when the finger is either below or above the center of the screen. The value of the Y offset may depend, in some embodiments, on the distance from the pointer finger to the center of the screen along the Y axis.

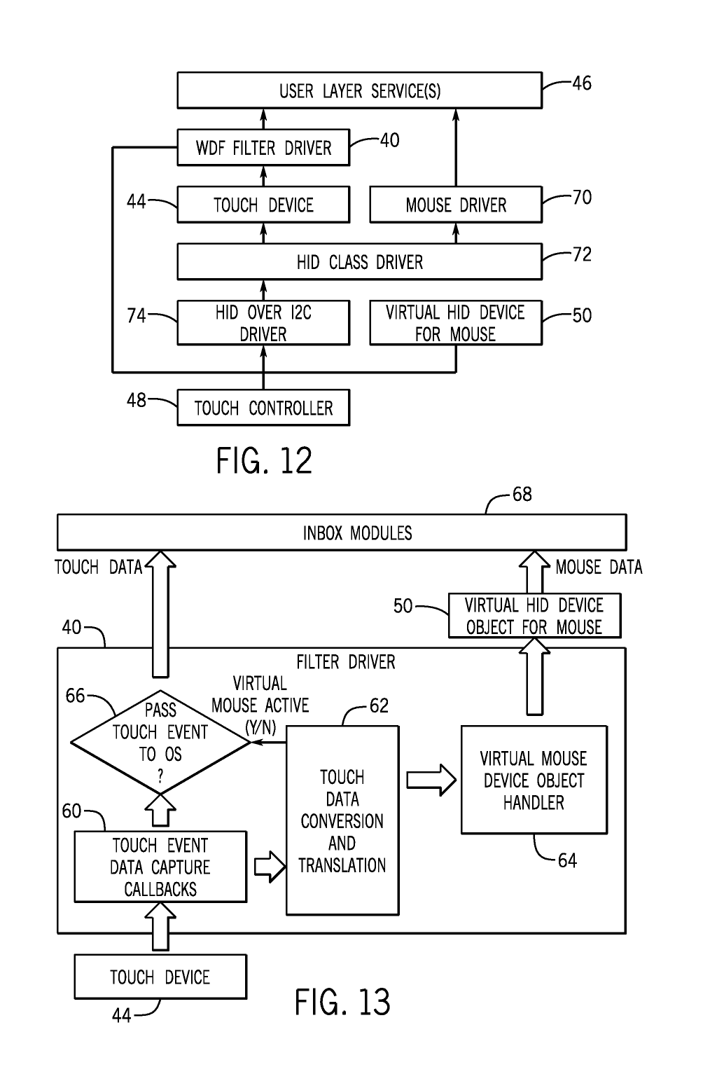

According to another embodiment, a kernel mode device filter (KMDF) driver 40, shown in FIG. 12, is located between the touch device Object Physical Device Object (PDO) 44 and user layer services 46. A PDO represents a logical device in a Windows operating system. The filter driver is touch vendor agnostic but is Windows specific in some embodiments.

The architecture may also support standard HID over 120 protocol using driver 74. It can support a physical mouse as well using mouse driver 70.

This filter driver captures all data transactions between the touch device and user layer services, especially the touch event data from an external touch controller 48. It processes this data and recognizes predefined finger gestures on the touch screen and then translates them into mouse events. These events are sent to an OS through the Virtual HID Mouse Physical Device Object (PDO) 50 and HID class driver 72.

The internal architecture of this filter driver 40 is shown in FIG. 13. The architectures shown in FIG. 13 and FIG. 11 refer to two different mouse over touch solutions. FIG. 13 shows the architectural design of a central processor filter driver based solution. This architectural design is implemented inside a Windows software driver running on CPU. It does not use the kernels shown in FIG. 11. It includes three major parts. Touch Event Data Capture Callbacks 60 is a callback function registered into every request to a touch device 44 object, as well as a set of data extraction functions. These functions are called whenever the touch device object completes a request filled with touch data. These functions extract the data of interest and sends that data to next inbox module 68, including X/Y coordinates, number of fingers on the touch screen and individual finger identifiers. Also, depending on the result of Virtual Mouse Active (Yes/No) from Data Conversion and Translation module 62, the callbacks decide whether to send the original touch event data to the OS or not (diamond 66).

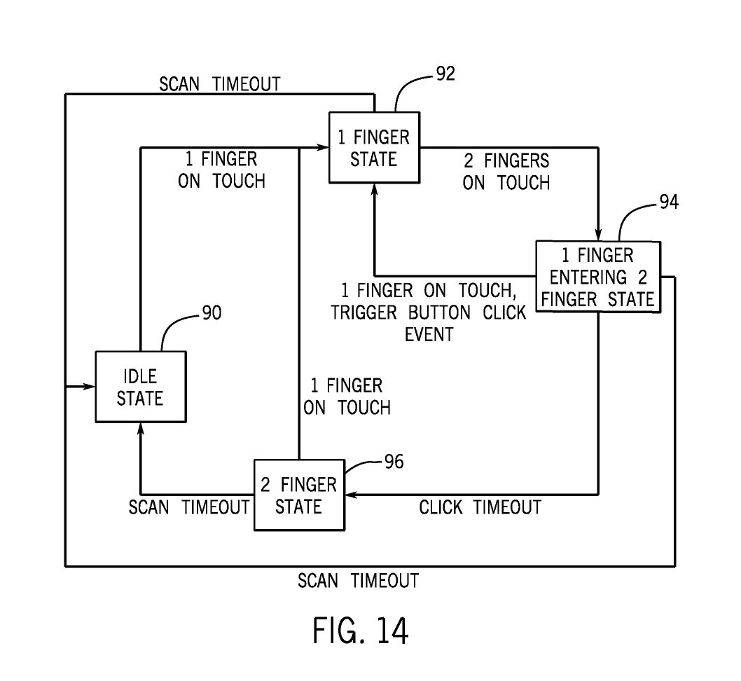

Touch Data Conversion and Translation 62 is the main logic part of filter, which recognizes predefined finger gestures, translates them into mouse data and decides (diamond 66) whether to enter Virtual Mouse mode or not. This part is state machine implemented as shown in FIG. 14.

Virtual Mouse Device Object Handler 64 receives converted mouse event data and packages it into HID input reports, and then sends the reports to the OS through Virtual Mouse Device Object 50.

Finger gestures are defined in one embodiment to work with a Virtual Mouse as shown in FIGS. 15, 16, 17 and 18. Three fingers staying on the touch screen without moving for a time period (e.g. three seconds) activates touch-to-event translation as shown in FIG. 15. This disables the filter driver from passing original touch event data to the OS. When touch-to-translation is active, putting three fingers on touch screen again deactivates this translation and allows the original touch event data to pass to the OS via Inbox modules 68 in FIG. 13.

If one finger only touches and moves as indicated by arrow A, the mouse cursor moves on screen as shown in FIG. 16 by arrow B. If two fingers touch and move together as indicated by arrow C, the mouse cursor moves, as indicated by arrow B, as if a Left Button Down (dragging and dropping icon I) was actuated as shown in FIG. 17 by arrow D.

If one finger touches, as shown in FIGS. 18A and 18B by the circle T and then another finger touches and then is removed (tap) within a time period (e.g. 200 ms) a mouse button click event is triggered. Recognition of whether a click on right or left button is intended depends on whether tapping finger F is on the left (FIG. 18A) or right (FIG. 18B).

To support touch-to-mouse event translation and gestures as discussed above, the state machine shown in FIG. 14 is implemented in the Touch Data Conversion and Translation module 62 of FIG. 13 in one embodiment.

There are four states in one embodiment illustrated in FIG. 14. In the Idle State 90 there is no finger on touch screen and no mouse event is generated. In a One Finger State 92, one finger is detected on touch and mouse move event is sent to OS, according to the distance and direction this finger moves on the touch. In a One Finger Entering Two Finger State 94, two fingers are detected on touch from one Finger state. However, it is uncertain whether this is a user finger tapping event or not. So the flow waits for a Click Timeout (e.g. 200 ms). If again only one finger is detected on touch screen before this time running out, the flow moves back to One Finger State 92 and triggers a LEFT/RIGHT Button Click Event. If this timeout occurs, the state will change to Two Finger State 96. In a Two Finger State, two fingers are detected on the touch screen and the cursor moves with a Left Button Down event sent to the OS, according to the distance and direction these two fingers move on the touch screen.

In addition, a Scan Timeout (e.g. 20 ms) equals twice the Touch Scan Interval in one embodiment. If no touch event received after this Scan Timeout, the user has removed all fingers from the screen and the flow goes back to Idle State.

In accordance with some embodiments, a touch input device, such as a touch screen, may be operated in mouse mode by touching the screen simultaneously with more than one finger. In one embodiment, three fingers may be utilized. The three fingers in one embodiment may be the thumb, together with the index finger and the middle finger. Then the index finger and the middle finger may be used to left or right click to enter a virtual mouse command.

In some embodiments, a system may detect simultaneous touching by multiple fingers on a touch input device. In the case of a three finger screen touch command, the system may determine whether the left or the right hand is on the device and the relative positions of the three fingers. One way this can be done is to resolve the nature of a triangle defined by the three points of contact and particularly its shape and from this, determine whether the user's left or right hand is on the device. This hand identification may be important in determining whether a left click or a right click is signaled. A left click or right click may be signaled in one embodiment by tapping either the index or middle finger on the screen depending on which of the left or right hands is used. In one embodiment, the left hand's index finger is in the right position, and the right hand's index finger is in the left position. Both of them are left clicking. So hand identification can be important is some embodiments.

The following clauses and or examples pertain to further embodiments:

One example embodiment may be a method comprising detecting contact on a touch input device, determining a location of said contact, and displaying a cursor at a position relative to said contact that varies based on the location of said contact. A method may also include moving the cursor from a first position more central relative to said contact to a second position less central of said contact, in response to said contact moving towards a screen edge. A method may also include moving said cursor about said contact based on proximity to a screen edge. A method may also include using vendor independent kernels to enable a mechanism to operate independently of touch vendor kernels. A method may also include loading said vendor independent kernels during initialization, running them on a graphics processing unit without dependence of any platform operating system. A method may also include exposing mouse input events to an operating system through a virtual mouse device object. A method may also include using a kernel mode driver to create the virtual mouse device object. A method may also include detecting whether the input device is in touch mode or virtual mouse mode, each mode being associated with different human interface device packets. A method may also include filtering out the packets of the undetected mode. A method may also include using a driver for implementing a virtual mouse mode.

Another example embodiment may include one or more non-transitory computer readable media storing instructions executed to perform a sequence comprising detecting contact on a touch input device, determining a location of said contact, and displaying a cursor at a position relative to said contact that varies based on the location of said contact. The media may include said sequence including moving the cursor from a first position more central relative to said contact to a second position less central of said contact, in response to said contact moving towards a screen edge. The media may include said sequence including moving said cursor about said contact based on proximity to a screen edge. The media may include said sequence including using vendor independent kernels to enable a mechanism to operate independently of touch vendor kernels. The media may include loading said vendor independent kernels during initialization, running them on a graphics processing unit without dependence of any platform operating system. The media may include said sequence including exposing mouse input events to an operating system through a virtual mouse device object. The media may include said sequence including using a kernel mode driver to create the virtual mouse device object. The media may include said sequence including detecting whether the input device is in touch mode or virtual mouse mode, each mode being associated with different human interface device packets. The media may include said sequence including filtering out the packets of the undetected mode. The media may include said sequence including using a driver for implementing a virtual mouse mode.

In another example embodiment may be an apparatus comprising a processor to detect contact on a touch input device, determine a location of said contact, and display a cursor at a position relative to said contact that varies based on the location of said contact, and a storage coupled to said processor. The apparatus may include said processor to move the cursor from a first position more central relative to said contact to a second position less central of said contact, in response to said contact moving towards a screen edge. The apparatus may include said processor to move said cursor about said contact based on proximity to a screen edge. The apparatus may include said processor to use vendor independent kernels to enable a mechanism to operate independently of touch vendor kernels. The apparatus may include said processor to load said vendor independent kernels during initialization, running them on a graphics processing unit without dependence of any platform operating system.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A computer-implemented method comprising:
detecting contact on a touch input device;
determining a location of said contact; and
displaying a cursor at a position relative to said contact that varies based on the location of said contact.

2. The method of claim 1 including moving the cursor from a first position more central relative to said contact to a second position less central of said contact, in response to said contact moving towards a screen edge.

3. The method of claim 1 including moving said cursor about said contact based on proximity to a screen edge.

4. The method of claim 1 including using vendor independent kernels to enable a mechanism to operate independently of touch vendor kernels.

5. The method of claim 1 including loading said vendor independent kernels during initialization, running them on a graphics processing unit without dependence of any platform operating system.

6. The method of claim 1 including exposing mouse input events to an operating system through a virtual mouse device object.

7. The method of claim 6 including using a kernel mode driver to create the virtual mouse device object.

8. The method of claim 1 including detecting whether the input device is in touch mode or virtual mouse mode, each mode being associated with different human interface device packets.

9. The method of claim 8 including filtering out the packets of the undetected mode.

10. The method of claim 1 including using a driver for implementing a virtual mouse mode.

11. One or more non-transitory computer readable media storing instructions executed to perform a sequence comprising:
detecting contact on a touch input device;
determining a location of said contact; and
displaying a cursor at a position relative to said contact that varies based on the location of said contact.

12. The media of claim 11, said sequence including moving the cursor from a first position more central relative to said contact to a second position less central of said contact, in response to said contact moving towards a screen edge.

13. The media of claim 11, said sequence including moving said cursor about said contact based on proximity to a screen edge.

14. The media of claim 11, said sequence including using vendor independent kernels to enable a mechanism to operate independently of touch vendor kernels.

15. The media of claim 11, said sequence including loading said vendor independent kernels during initialization, running them on a graphics processing unit without dependence of any platform operating system.

16. The media of claim 11, said sequence including exposing mouse input events to an operating system through a virtual mouse device object.

17. The media of claim 16, said sequence including using a kernel mode driver to create the virtual mouse device object.

18. The media of claim 11, said sequence including detecting whether the input device is in touch mode or virtual mouse mode, each mode being associated with different human interface device packets.

19. The media of claim 18, said sequence including filtering out the packets of the undetected mode.

20. The media of claim 11, said sequence including using a driver for implementing a virtual mouse mode.

21. An apparatus comprising:
a processor to detect contact on a touch input device, determine a location of said contact, and display a cursor at a position relative to said contact that varies based on the location of said contact; and
a storage coupled to said processor.

22. The apparatus of claim 21, said processor to move the cursor from a first position more central relative to said contact to a second position less central of said contact, in response to said contact moving towards a screen edge.

23. The apparatus of claim 21, said processor to move said cursor about said contact based on proximity to a screen edge.

24. The apparatus of claim 21, said processor to use vendor independent kernels to enable a mechanism to operate independently of touch vendor kernels.

25. The apparatus of claim 21, said processor to load said vendor independent kernels during initialization, running them on a graphics processing unit without dependence of any platform operating system.
